(19) United States
(12) Patent Application Publication
(10) Pub. No.: US 2014/0122627 A1
(43) Pub. Date: May 1, 2014

(54) Triggered Message System

(71) Applicant: Max Gregory Arnold, New Orleans, LA (US)

(72) Inventor: Max Gregory Arnold, New Orleans, LA (US)

(21) Appl. No.: 14/064,025

(22) Filed: Oct. 25, 2013

Related U.S. Application Data
(60) Provisional application No. 61/719,094, filed on Oct. 26, 2012.

(51) Int. Cl. H04L 12/58

(52) U.S. Cl. CPC H04L 51/02
USPC 709/206

(57) ABSTRACT

A triggered message system provides individuals with communications based on trigger events. Triggered messages may be text messages, voice messages, or other messages. Delivery of the triggered messages to the proposed recipient may be triggered by events such as the location of a proposed recipient, the occurrence of an event in the proposed recipient's life, or the passage of time.

This disclosure claims priority to U.S. provisional patent application No 61/719,094 filed on Oct. 26, 2012 titled Triggered Message System.

### FIELD OF DISCLOSURE

The present disclosure relates to automated message systems.

### BACKGROUND OF DISCLOSURE

Individuals communicate with their contacts through messages such as emails, text messages, and voice messages. Such messages are conveyed to an individual's contact as soon as possible. For example, a message is sent immediately to an email inbox, a text message inbox, or voice message inbox. Typically, the contact retrieves (and therefore receives) the message as soon as possible.

### SUMMARY

An embodied system is a method for delivering triggered messages (i.e., messages delivered after or in response to a trigger event). The method includes receiving a message and a trigger event from an individual. The trigger event, for example, could be based on a location of the intended recipient, on a date (e.g. birthday), or on the occurrence of an event (e.g., a death, election, etc.). The method further includes monitoring for the trigger event, determining a probability that the trigger event has occurred, and delivering the received message to an intended recipient upon the probability exceeding a threshold. Determining the probability that the trigger event has occurred may include accessing publications (e.g., newspapers, websites, blogs, etc.) for evidence that the trigger event has occurred (i.e., for trigger event data). In the alternative, determining the probability that the trigger event has occurred could include comparing a recent level of activity on account to a previous level of activity on an account. For example, a system could monitor the level of activity of an email account or financial institution account (e.g., bank account). After death, a user would no longer access his account, so an embodiment count monitor account access as an indicator of whether a death occurred.

Another embodiment is an apparatus including a processor, a communication interface, and a memory for storing instructions. Instructions stored on memory carry out actions including receiving a message, receiving a trigger event, monitoring for the trigger event, determining a probability that the trigger event has occurred, and delivering a message to an intended recipient upon the probability exceeding a threshold.

### BRIEF DESCRIPTION OF THE DRAWINGS

FIG. 1 depicts a method for providing triggered messages in response to a trigger event;

FIG. 2 depicts system for providing triggered messages on behalf of a user in response to a trigger event;

FIG. 3 depicts various devices upon which a recipient could receive triggered messages in response to trigger; and

FIG. 4 depicts an apparatus or system for determining trigger events and providing triggered messages on behalf of a user.

### DISCLOSURE OF EMBODIMENTS

Embodied systems automatically provide a target audience or individual with a message (i.e., triggered message) upon the occurrence of a trigger event. Nonlimiting examples o trigger events are dates (e.g., Aug. 11, 2013, a birthday), a death, or a particular team winning a sporting event. Messages may be entered into a mobile telephone. For example, a message may be entered by hand through a keyboard or spoken into the mobile telephone. The messages, in some embodiments, are stored in the cloud on a secure server. Ideally, the server is secure and safe from natural disasters such as earthquakes and hurricanes. Accordingly, storage of the messages may be duplicated (e.g., in multiple locations) for safety.

Embodied systems can be used in many scenarios. For example, a soldier who is entering a battle can leave a message for particular individuals in case the soldier loses his life or is otherwise rendered incapacitated in the battle. A person undergoing a medical procedure or event could also use an embodied system to store a triggered message for delivery upon a trigger event. In each case, the individual could move the trigger event either manually or automatically upon the occurrence or nonoccurrence of the trigger event. For example, a soldier fighting a war could set up his triggered message to be delivered if he does not log into an email account or make a telephone call every 72 hours. Alternatively, the soldier could set up his triggered message to be delivered unless he manually changes the trigger or turns off the trigger after a given time. As a safety measure (so as not to alarm an intended recipient), embodied systems may remind a soldier, or attempt to remind the soldier, before sending the triggered message. For example, if the soldier forgets to log into his email account, turn off the trigger, or does not otherwise indicate the trigger did not occur, the system may attempt to ping the soldier to ensure sending the triggered messages is still appropriate. This obviously prevents the recipient from believing the trigger event occurred if it did not.

Embodied systems can also store a series of messages (as opposed to just one message), and the series of messages can be sent according to a series of triggers. For example, a user could record a message for each of the birthdays of his grandson. If the grandson reached the age of five years old, the user would have a particular message delivered for that day. Likewise, once the grandson reached the age often years old, the user would have a particular message delivered for that birthday. In this way, the user could store messages for later delivery that the user felt would be appropriate for his grandson as the grandson reached each milestone.

Embodied systems could deliver triggered messages to recipients in a particular selected format (e.g., an SMS message) or on all available formats, even if the format is non-existent at the time the message is stored. For example, if a particular medium for delivery of messages is not available (i.e., not developed) when the user leaves the triggered message, embodied system could convert the triggered message for delivery using the then future delivery system. In this way, embodied systems would “keep up with the times,” regardless of the technology that was available at the time the user left the triggered a message. Also, the user would not have to anticipate the types of media on which a recipient wished to receive to message. If the recipient wished to receive the message on a smart TV or projector, for example, the recipient could do so.

In some embodiments, systems prompt the recipient for the preferred delivery system or method. For example, a system would instruct a recipient, upon the occurrence of a trigger event, as follows: “We have been asked to deliver a triggered message from [user name], how would you like to receive the message?” In this way, the recipient specifies how he wishes to receive the triggered message. Embodied systems accordingly automatically determine whether to stream a triggered message or deliver the message to the user's email address, IP address, smart phone, smart TV, hologram projector, SMS account, physical mailbox, MMS account, social media account and so on.

In addition, embodied systems may automatically look up delivery addresses of recipients. For example, a user may speak into an embodied device the following text, “please deliver upon my death a message to all my family members telling them that I love them.” system may automatically convert the message and store it as, “[User's Name] wanted you to know upon his death that he loved you.” The system would accordingly go through the user's contact list and determine which recipients would receive the message. Those contact entries in the user's contact database designated with, for example, a “family” designation would receive the message.

Some embodied systems automatically check public or private databases to determine whether a trigger (e.g., a death) has occurred. For example, to coroner's office or a database containing death certificates can be checked. Similarly, Social Security databases can be accessed to detect trigger events. Local newspapers containing obituaries may also be accessed and analyzed to determine whether a trigger has occurred. In some embodiments, an automatic search of obituaries runs along with other associated text searches to confirm whether a trigger event has actually occurred. For example, if a text search of obituaries in a publication relevant to the user returns a hit for both the user's name and also for other individuals in the user's contact list or recipient list, further investigation of whether the trigger event occurred would be warranted. For example, potential recipients could all be part of the “survived by” list in an obituary. Therefore, further investigation could be warranted to determine whether the trigger event had occurred. As verification, an embodied system could determine whether the user's cell phone or payment devices (credit cards) were recently used. This may be done by automatically accessing banking records with known log in credentials. Similarly, an embodied system may determine whether a user has logged into an email account or other such account (financial account, social media account) to determine whether a trigger event has occurred. Some systems send a text message or other query to the recipient to probe whether the trigger event has occurred.

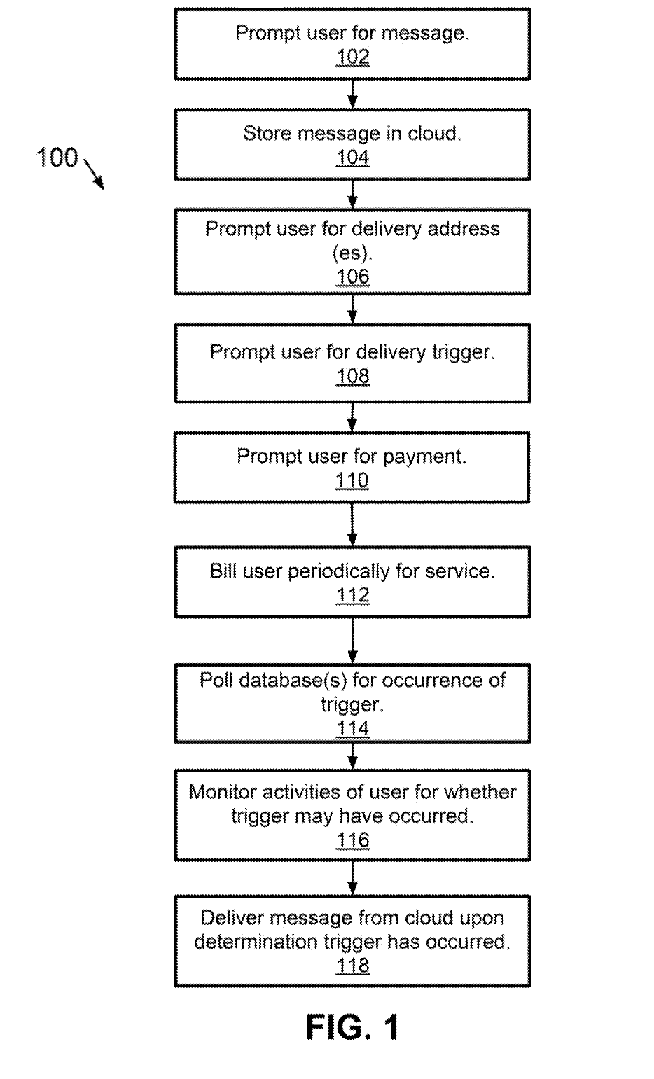

FIG. 1 is a flowchart depicting representative steps taken by an embodied system or method. First, a user is prompted in action 102 for a triggered message. The user may he prompted visually (e.g., told “enter your message”) on a screen or through spoken text, as examples. The message is received and stored (action 104), for example, in the cloud. In some embodiments, a user speaks the message into a mobile phone. The message, as it is received, may be streamed in real time and sent to the cloud. Alternatively, it may be stored locally for later sending (e.g., through as cheaper connection, through a connection not currently available, and so on) to the cloud. Embodied systems may process the message to remove background noise, add background music, or provide other desired effects. The message may include typed text, video content, audio content, and any combinations of the above or other content a user may wish to later deliver to as recipient.

After prompting the user for the message and receiving the message, embodied systems prompt the user for delivery addresses (action 106) of proposed recipients if necessary. In other systems, an initial stream of text is processed to determine whether deliver addresses are included in (or can be derived) from an initial entry by the user (e.g., such as “send to all my family members a message upon my death that tells them I love them”). The delivery addresses may be in some combination. Email addresses, phone addresses, physical addresses (i.e., postal addresses), and so on. A single recipient may have multiple addresses.

The user is then prompted for a delivery trigger (action 108) if necessary. The delivery trigger could be a date or the occurrence of events, as examples. The user could be probed to outline the methods by which a trigger determination should be made by the system. In some embodiments a specific date such as a recipient's birthday is used as the trigger event. Embodied systems may also receive input that results in sending, for example, all of his friends a birthday wish on their birthdays. In such cases, an embodied system would go to the user's contact list (or a public or private database) and determine each recipient's birthday, for example.

Optionally, as shown in FIG. 1, the user can be prompted for payment (action 110). The service may be billed to a mobile phone account or other account associated with a mobile phone (e.g., near field payment system). In some cases, the payments are set up for periodic billing (action 112 using credit card or banking information) to maintain the service. In this way, embodied systems collect money and return a profit to operators.

As shown in FIG. 1, embodied systems poll a database (action 114) to see whether a trigger event has occurred. Polling the database may be in response to receiving an initial indication that a trigger event has occurred. For example, polling an obituary (an initial or top level inquiry) in a local newspaper (on the web) may return a user's name. In such cases, a secondary inquiry would be warranted. Accordingly, disclosed systems investigate a database (e.g., scrape a local web page for a newspaper, log into a government database) such as death certificate database as a secondary inquiry. As such, embodied systems can have varying or multiple levels of inquiry to determine whether a trigger event had occurred. This can be used to determine a likelihood (or probability) that trigger event occurred.

Accordingly, a determination that the trigger event occurred would be based on the likelihood that the trigger event occurred. This would be determined by comparing a calculated likelihood to a threshold level received by the user. For example, if a user's name appears in an obituary and the user has had no bank activity for three months (and previously had daily bank activity), a determination may be made a user is 90% likely to be deceased. In some cases, the user can set the threshold (e.g., above 90%). This would hopefully prevent a loved one from improperly receiving a triggered message indicating, for example, that a death had occurred. Algorithms for determining such a likelihood are application-specific and potentially user-specific, and are within the ability of one or ordinary skill to design and implement (e.g., program) without undue experimentation.

In addition to polling databases to determine whether an occurrence of the trigger occurred, embodied systems may monitor the activities of the user (action 116) to determine whether the trigger may have occurred. (See FIG. 1). For example, an email account, instant message (IM) account, SMS account, or other social media account of the user can be monitored for activity. If the trigger event is a death, and the user typically sends 100 emails per day, monitoring the email account and determining that zero emails had occurred for the last seven days would be an indication that the user was either incapacitated or perhaps dead (or had a broken computer, or was on vacation from work). At any rate, the system could perform secondary investigations (including by logging into an email account and checking the “sent” folder) and apply a weight to received data to determine the likelihood that the trigger event had occurred based on the available data. Alternatively, monitoring the activity of the user could be part of the secondary investigation based on other evidence (e.g., appearing in an obituary).

As shown in FIG. 1, some embodied systems attempt to contact the user if a trigger event is suspected. For example, the system automatically sends a text message to the user, phones the user, or emails the user to determine whether a trigger event occurred. The system might require the user to enter a password or other security code to verify the identity (i.e., authenticate) of the user. Alternatively, the system performs voice recognition on the user's voice as verification. If the trigger is confirmed, as shown in FIG. 1, embodied systems deliver the triggered message (action 118). In some embodiments, a message is delivered from the cloud (e.g., the Internet) by streaming or download, as examples.

Some embodied systems are designed to send triggered messages to loved ones. Other embodied systems can send more business-like messages to financial, institutions, a government entity, landlords, and the like. Embodied systems are not intended to necessarily send one type of message or the other, but instead allow sending myriad message types.

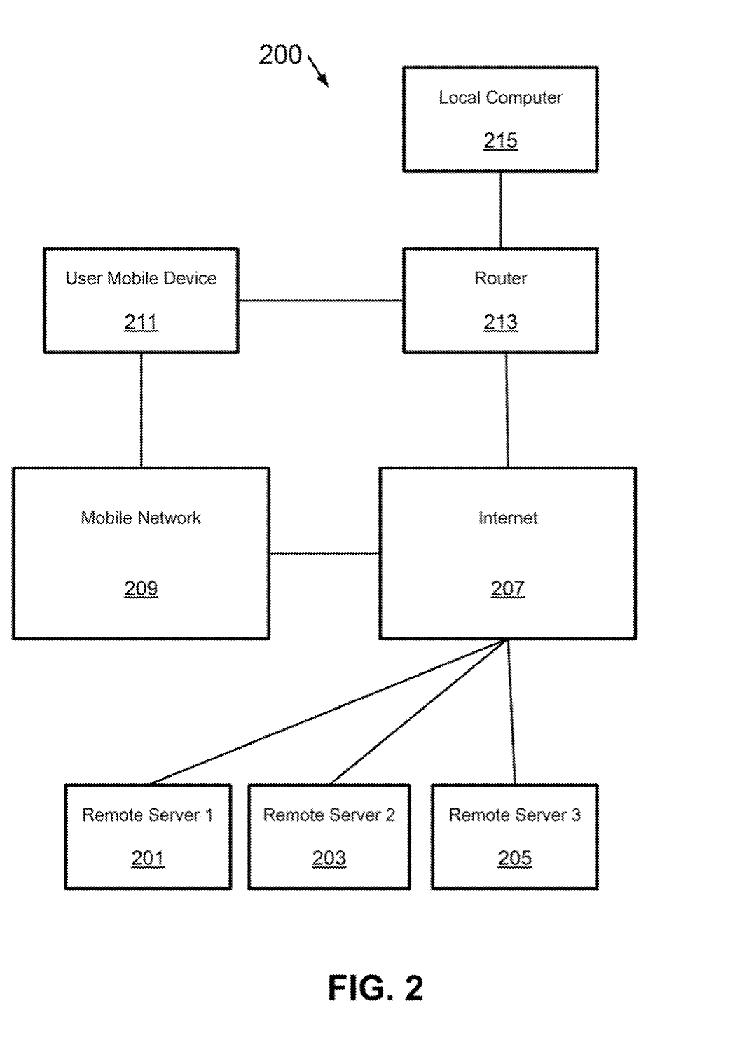

FIG. 2 illustrates a network for providing and receiving embodied services (e.g., sending or delivering triggered messages). As shown, a user mobile device 211 is provided for entering triggered messages by the user. The user mobile device 213 may be mobile phone, tablet, or other portable (i.e., mobile) appliance. As shown, it communicates wirelessly with a router 213 and local computer 215. Alternatively, it communicates wirelessly with a mobile network tower 209.

The user mobile device 211 can be used to store (temporarily or permanently) a triggered message on memory on the mobile device. The triggered message can be stored locally as a duplicate or alternative at the local computer 215 which is communicatively coupled to the router 213. As still another alternative, the triggered message can be stored on any or all of a first remote server 201, a second remote server 203, or a third remote server 205. The triggered message is therefore stored in a secure way with redundancy.

As shown in FIG. 2, the first remote server 201, the second remote server 203, and the third remote server 205, if they are located remotely from one another, provide redundancy in the event of a natural disaster, as an example. Any or all of the remote servers also may provide functionality, through software saved on server memory, for receiving triggered messages, receiving contact information, and other hosting services necessary for embodiments. Alternatively, each remote server shown in FIG. 2 represents online storage accessible to a user, provided by different third party services/companies. Disclosed embodiments represented by FIG. 2 therefore permit other hosted services to provide online storage of triggered messages. In this way, the user can store and add to, on his or her online storage account, certain content that would be distributed upon a trigger event. Distribution of the content could merely result from an embodied service electronically pointing to the content (e.g., through providing a URL), or otherwise granting the recipient access to the content from the third party cloud-based account. This would provide, for example, a user of an online account as with stored pictures the ability to automatically distribute those pictures to loved ones (perhaps that were tagged in the pictures) upon the death of the account holder.

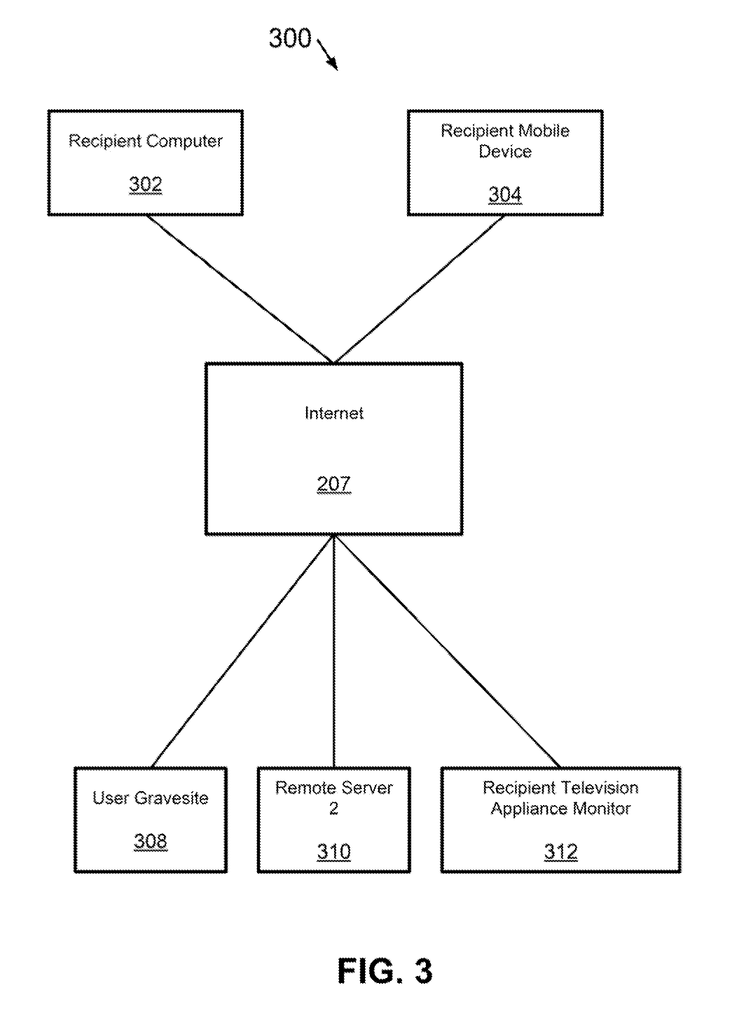

FIG. 3 depicts representative devices by which a triggered message can be delivered to the recipient, or received by the recipient. For example, a triggered message can be delivered to a recipient's computer 302, a recipient's mobile device 304, the recipient's television appliance 312, or other means (e.g., a user's car, the user's navigation system, etc.). As shown, the triggered message can be delivered at a user's gravesite 308. The user's gravesite 308 or other memorial location for example, may include technology (e.g. via Bluetooth and Wi-Fi modems) that is in communication with a remote server (e.g., remote server 201 in FIG. 2) over Internet 207 or other network to deliver (e.g., stream, download) triggered messages to a recipient.

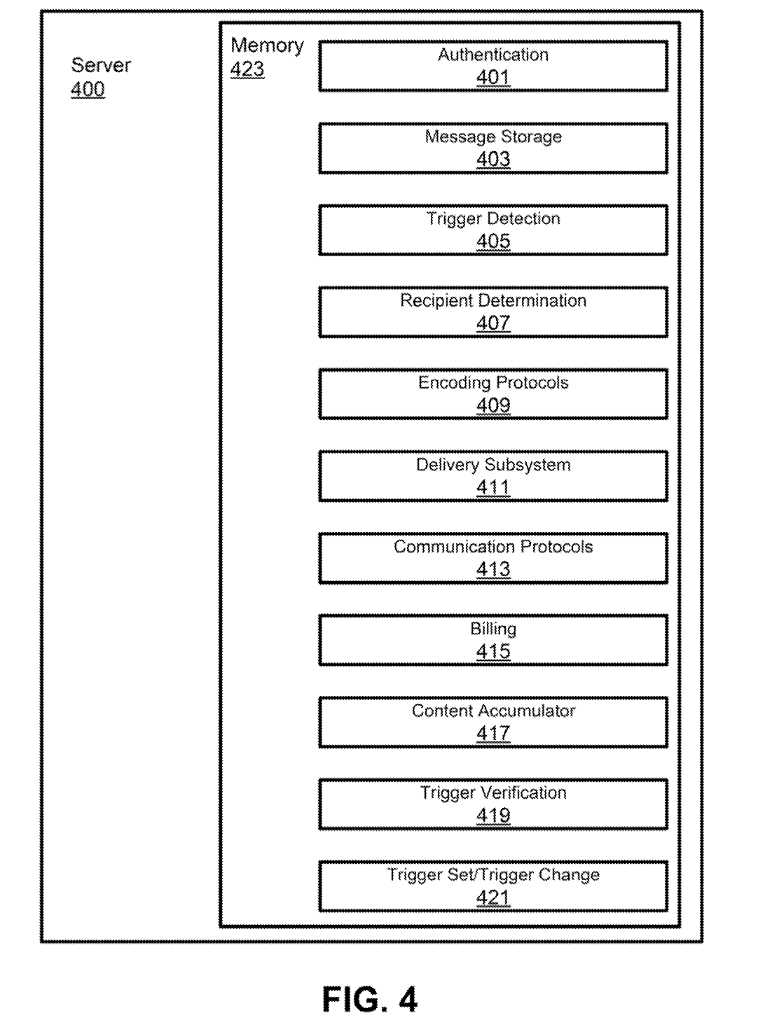

FIG. 4 depicts a server 400 (e.g., typical of remote server 201, 203 or 205 of FIG. 2), with memory 423, for providing embodied services. An authentication module 401 authenticates a user to an embodied system (e.g., email system) through login or biometric data, for example. A message storage module 403 (e.g., RAM, ROM, storage disk, cloud storage, online storage service, network storage) may include memory (local or remote) for storing a triggered message provided by the user. The trigger detection module 405 checks calendars, checks a clock, checks databases, and peril other relevant actions (e.g., polls databases) to determine whether a trigger event has occurred. In addition, a determination is made whether as message stored by or in the message storage element 403 should be delivered. A recipient determination module 407 determines which recipients should receive a triggered message.

In some embodiments, a user can say “all of my family members” as the intended recipient(s) of the triggered message. In such cases, the recipient determination module 407 determines which persons stored in a user's contact list, for example, should receive the triggered message. An encoding protocols module 409 transforms messages, when appropriate, for consumption by the recipient in whatever format he or she chooses. For example, as shown in the previous figures, a recipient may receive a triggered message on a television, computer monitor, mobile phone, or other consumer device. Accordingly, the encoding protocols module 409 provides streaming or downloadable content compatible with such technologies. To that end, the delivery subsystem module 411 is included within the server for providing the content. The communications protocols module 413 formats digital information in an appropriate protocol for communication over a network such as the Internet or a mobile network. In addition, the communication protocols module 413 can communicate through near field communications or local area network communications (e.g., Bluetooth, Wi-Fi, etc.) to provide a triggered message to a recipient device. In such cases, only upon a trigger event as determined by the trigger detection element 405 on the server and FIG. 4, or upon detection of a trigger event as determined by the recipient's local application, would the recipient be able to receive the content of the triggered message. While the transfer of the triggered message would, in such eases, occur before a triggering event, only upon the trigger event would the triggered message be accessible by the recipient.

A billing module 415 provides a way to generate revenue by billing users for embodied services by accessing financial accounts or credit accounts. A content accumulator module 417 optionally gathers content over an extended period of time for building up a triggered message. For example, photos could be accumulated, or GPS tracking data could be accumulated. The trigger verification module 419 provides for verification of a trigger event, to prevent sending a triggered message unless a threshold level of probability (e.g., 90%) is reached that a triggering event has actually occurred. The trigger set/trigger change module 421 provides the user with the ability to set a trigger based on, for example, a death, a public event, a personal event (e.g., birthday), or the like. Trigger set/trigger change module 421 also provides the ability for the recipient to change the trigger event remotely, for example over the Internet or through a client application.

A further embodied system delivers a triggered message based on the location of a recipient. The user may wish to record a message that is delivered once as recipient reaches, for example, a geographic region, a football venue, a restaurant, or a cemetery. For example, a user at a favorite restaurant may record a triggered message via a cell phone as follows, “This is my favorite restaurant, and if you are here you must try the fried shrimp.” An embodied system would receive this message from the user, receive a recipient list, and receive a trigger event (e.g., when the friend visited the restaurant). For example, a user would speak instructions into an embodied system (e.g. through a mobile device such as a phone), “please deliver to all my friends on my contact list the following message if they come within 5 miles of this restaurant and if they ask their mobile device for restaurant recommendations.” Alternatively, the user could speak instructions into an embodied system such as, “please deliver to all my friends on my contact list the following message if they are inside this restaurant.” As such, embodied systems delivery location triggered messages, based upon the location of the recipient.

Another embodied system, for example, would deliver a message to an intended recipient that is visiting the gravesite of the user. For example, a user could instruct an embodied system to deliver a particular message via text message to anyone determined by GPS to be visiting the user's gravesite. In this way, a triggered event could be based on both: (1) the death of the user; and (2) a visit by the intended recipient to a particular location.

In some eases, a user could set a trigger event to be a recipient being a certain distance from a location. For example, a user could set a trigger event to be that his child is within 2 miles of a particular location (e.g., where the user proposed to his wife, the mother of the child). The triggered message could be, “Two miles from here is where I propose to your mother in 1972.” The trigger event could be a combination of (1) the user's death; and (2) the child being within 2 miles of the location of the proposal. Alternatively, the trigger event could be one or the other of the occurrence of an event or the location of the recipient.

An example embodiment would be if a fisherman had a particularly good day of fishing at a fishing spot, and for some reason wished to share that information with one or more of his friends. The user could leave a message to a select friend or group of friends that said something like, “On Sep. 18, 2012, [insert name] and I caught 15 slot redfish and 5 speckled trout on plastic worms a hundred yards to your right toward the buoy.” In this way, the user could leave a triggered message to his friends. Embodied system would store the triggered message and monitor the recipient's location or other databases, for example, to determine when the recipient should receive the triggered message. Embodied system could also monitor the types of systems (e.g. a tablet, a phone, or other device) in use by the recipients at that time and select the device on which the recipient received the device. Accordingly, an embodied system or service would either stream or download the appropriate message to the appropriate recipient device. Again, the trigger event could be some combination of the recipient's location, the user location, or an occurrence trigger (e.g. a date, an occurrence, or some fixed or variable passage of time).

In the past, a user might have carved into a wooden table at an outdoor restaurant or location, for example, “[insert name] was here.” Embodiments provide an alternative to such activity, based on the recipient's location. Rather than defacing the wooden table, for example, a user can leave an electronic message that is later received by the recipient that says, “[insert name] was here.” In some embodiments, the message could be customized to the recipient. For example, the message could be, “Your uncle [insert name] was here on Sep. 12, 2012” for one recipient and, “Your older brother was here on Sep. 12, 2012” for another recipient. Embodied systems could automatically determine the proper context and text to use for a message or messages delivered by the user to the system.

In such systems, servers that provide the service would have to interface with multiple networks, potentially, to accommodate delivery of the messages to all intended recipients.

1. A method of delivering triggered messages, the method comprising:
receiving a message;
receiving intended recipient data;
receiving a trigger event;
monitoring for the trigger event;
determining a probability that the trigger event has occurred; and
delivering the message to an intended recipient upon the probability exceeding a threshold.

2. The method of claim 1, wherein:
the trigger event is based on a location of the intended recipient.

3. The method of claim 1, wherein:
the trigger event is based on a date.

4. The method of claim 1, wherein:
the trigger event is based on the occurrence of an event selected from a death or a birthday.

5. The method of claim 1, wherein determining a probability that the trigger event has occurred comprises:
polling publications for trigger event data.

6. The method of claim 1, wherein determining a probability that the trigger event has occurred comprises:
sending a verification communication to a user.

7. The method of claim 1, wherein determining a probability that the trigger event has occurred comprises:
comparing recent level of activity on an account to a previous level of activity on the account.

8. The method of claim 7, wherein the account is an email account.

9. The method of claim 7, where in the account is a financial account.

10. A system for providing a triggered message, the apparatus comprising:
a processor;
a communication interface;
a memory, wherein the memory comprises instructions for carrying out:
receiving a message;
receiving intended recipient data;
receiving a trigger event;
monitoring for the trigger event;
determining a probability that the trigger event has occurred; and
delivering the message to an intended recipient upon the probability exceeding a threshold.

11. The system of claim 10, wherein the memory further comprises instructions for carrying out:
an authentication system for authenticating a user.

12. The system of claim 10, wherein the memory further comprises instructions for carrying out:
an encoding system for encoding messages based on recipient requirements.

13. The system of dam 10, wherein the memory further comprises instructions for carrying out:
a delivery system for transferring the triggered message before the triggering event, wherein triggered message becomes accessible by the recipient only after the trigger event.

14. The system of claim 10, wherein the memory further comprises instructions for carrying out:
a billing system for billing a user.

15. The system of claim 10, wherein the memory further comprises instructions for carrying out:
a content accumulation system for gathering content over an extended period of time for building up the triggered message.

16. The system of claim 10, wherein the memory further comprises instructions for carrying out:
a trigger verification system to seek verification from the user before sending a triggered message.

17. The system of claim 10, wherein the memory further comprises instructions for carrying out:
a recipient determination module for determining who should receive a triggered message.
